(19) United States
(12) Patent Application Publication
(10) Pub. No.: US 2007/0240719 A1
(43) Pub. Date: Oct. 18, 2007

(54) Portable air-purifying system

(76) Inventor: Raul Duarte, Belleville, IL (US)

Correspondence Address: Raul Duarte, 1 Eleventh Fairway Court, Belleville, IL, 62220, US

(21) Appl. No.: 11/406,479

(22) Filed: Apr. 18, 2006

(51) Int. Cl. A62B 23/02; A62B 7/10; A62B 18/08

(52) U.S. Cl. 128/205.27; 128/206.12; 128/205.29

(57) ABSTRACT

A respirator includes a face mask and a housing assembly coupled in flow communication to the face mask. The face mask includes an inlet opening and a seal. The inlet opening is configured to channel treated air into the face mask. The face mask seal is configured to prevent contaminants and untreated air from entering the mask. The housing assembly includes a first filter assembly, a second filter assembly coupled in flow communication downstream from the first filter assembly, and an ultraviolet light source coupled in flow communication between the first and second filter assemblies. The ultraviolet light source is configured to substantially prevent microorganisms discharged from the first filter assembly from entering the inlet opening through the second filter assembly.

### BACKGROUND OF THE INVENTION

This invention relates generally to breathing apparatuses, and more particularly, to a portable powered air-purifying breathing apparatus that utilizes ultraviolet light to substantially prevent biological and viral contaminates from being breathed by a user.

Airborne bacteria and/or viruses in the environment may cause infection and disease if inhaled by a person. A variety of breathing apparatuses have been used to facilitate providing breathable air to users in hazardous environments. For example, at least some known breathing apparatuses generally require that the user's face, or at least the user's mouth and nose, be substantially enclosed within an air-tight mask to facilitate protecting the user from contaminants in the environment and to enable the user to breathe clean, toxin-free air. Moreover, at least some known breathing apparatuses include at least one filter that substantially filters out or absorbs contaminants that might otherwise be breathed by a person coming in contact with such matter.

For example, at least some known breathing apparatuses are air filtration respirators that employ filter canisters which filter harmful materials and/or chemicals from the air provided to the user. Known air filtration respirators can take one of two forms, either a purely negative pressure device, or a blower-assisted device. In a purely negative pressure air filtration respirator the user is required to draw air through filter canisters with his lungs. In contrast, in a blower-assisted device, the user is assisted in drawing the air through the filter canister via an electronic blower that is coupled in-line with the air flow. The blower-assisted device is typically referred to in the industry as a Powered Air Purifying Respirator (“PAPR”).

Many known air filtration respirators protect the user from gasses or vapors that may be present in the air. For example, U.S. Pat. Nos. 6,277,178, 5,944,873, and 5,492,882, each describe various absorbent filter elements which remove particulate matter that may be present in air supplied to a user of a respirator. Although such respirators may be effective at removing particulate mater from air supplied to a user, none of these patents describes or suggests a means of protecting a user from chemical, biological, or viral contaminants that may be present in the air supplied to the user. Other issued patents are directed to breathing apparatuses that may reduce the threat of biological or chemical atmospheric contamination through the use of devices that filter out or adsorb such contaminants. For example, U.S. Pat. No. 6,681,765 is directed to a respirator that includes a multi-stage filter that includes a second stage of the filter having one or more materials which can facilitate rendering harmless biological materials prior to being inhaled by the user.

Each of the aforementioned patents described above relies on an absorbent filter element as the primary mechanism to remove biological or chemical contaminants from a user's airflow, but none of the referenced patents describes or suggests a means of reducing germicidal contaminants or living microorganisms from the user's airflow. Such contaminants may be too small to be captured by the filter canisters. Moreover, the filtration devices described in each of the patents may be limited by the life expectancy of the absorbent filter media. As such, each of the aforementioned patents may provide only limited protection to a user.

### BRIEF DESCRIPTION OF THE INVENTION

In one aspect, a respirator is provided. The respirator includes a face mask and a housing assembly coupled in flow communication to the face mask. The face mask includes an inlet opening and a seal. The inlet opening is configured to channel treated air into the face mask. The face mask seal is configured to prevent contaminants and untreated air from entering the mask. The housing assembly includes a first filter assembly, a second filter assembly coupled in flow communication downstream from the first filter assembly, and an ultraviolet light source coupled in flow communication between the first and second filter assemblies. The ultraviolet light source is configured to substantially prevent microorganisms discharged from the first filter assembly from discharged to the user through the second filter assembly.

In another aspect, an air-purifying respirator is provided. The respirator includes an enclosure, at least one inlet, a filter assembly, a fluid connection apparatus, and a light source. The enclosure defines a single substantially contiguous enclosed interior and the inlet guides ambient air to the enclosure. The filter assembly is positioned within the enclosure and the fluid connection apparatus guides filtered air from an outlet of the filter assembly to be breathed by a user. The light source is positioned in an air path upstream from the filter assembly and is configured to prevent microorganisms from entering the fluid connection apparatus through the filter assembly.

In a further aspect, a powered air-purifying respirator (PAPR) is provided. The PAPR includes a housing configured to be carried by a user, a first filter assembly, a second filter assembly, an ultraviolet light source, and a blower. The housing includes at least one inlet port for receiving air to be channeled to the user. The first filter assembly is coupled externally to the housing in flow communication with the housing inlet port, and the second filter assembly is coupled in flow communication downstream from the first filter assembly via a flow path defined within the housing. The ultraviolet light source is coupled in flow communication within the flow path and is adapted to expose air discharged from the first filter assembly to ultraviolet light for a predetermined amount of time to facilitate preventing microorganisms from being inhaled by the user. The blower draws air into the PAPR housing through the first filter assembly.

In another aspect, a breathing system is provided. The breathing system includes a powered air-purifying respirator having a PAPR enclosure and a blower that pulls air through the PAPR enclosure, a facepiece, and an air path coupling the facepiece to the powered air-purifying respirator. The PAPR enclosure includes a light source and a filter assembly downstream from the light source. The facepiece is configured to cover a user's nose and mouth in a substantially airtight connection. The light source is configured to facilitate preventing microorganisms from being inhaled by the user through the filter assembly.

### BRIEF DESCRIPTION OF THE DRAWINGS

FIG. 1 is a schematic illustration of an exemplary breathing apparatus that may be used to supply uncontaminated air to a user;

FIG. 2 is a schematic illustration of an exemplary battery control circuit that may be used with the breathing apparatus shown in FIG. 1;

FIG. 3 is a schematic illustration of an exemplary lamp control circuit that may be used with the breathing apparatus shown in FIG. 1; and

FIG. 4 is a schematic illustration of an exemplary blower control circuit that may be used with the breathing apparatus shown in FIG. 1.

### DETAILED DESCRIPTION OF THE INVENTION

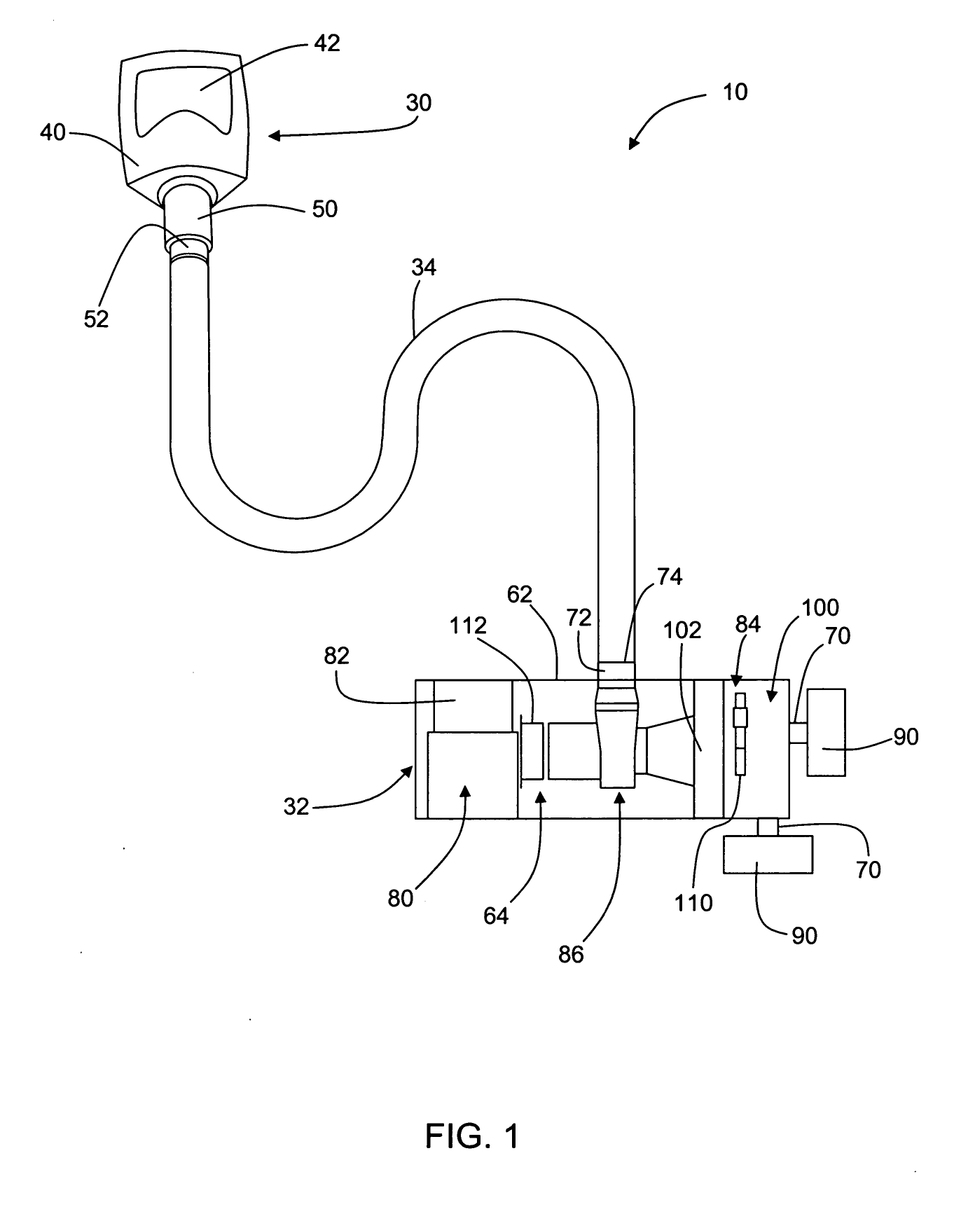

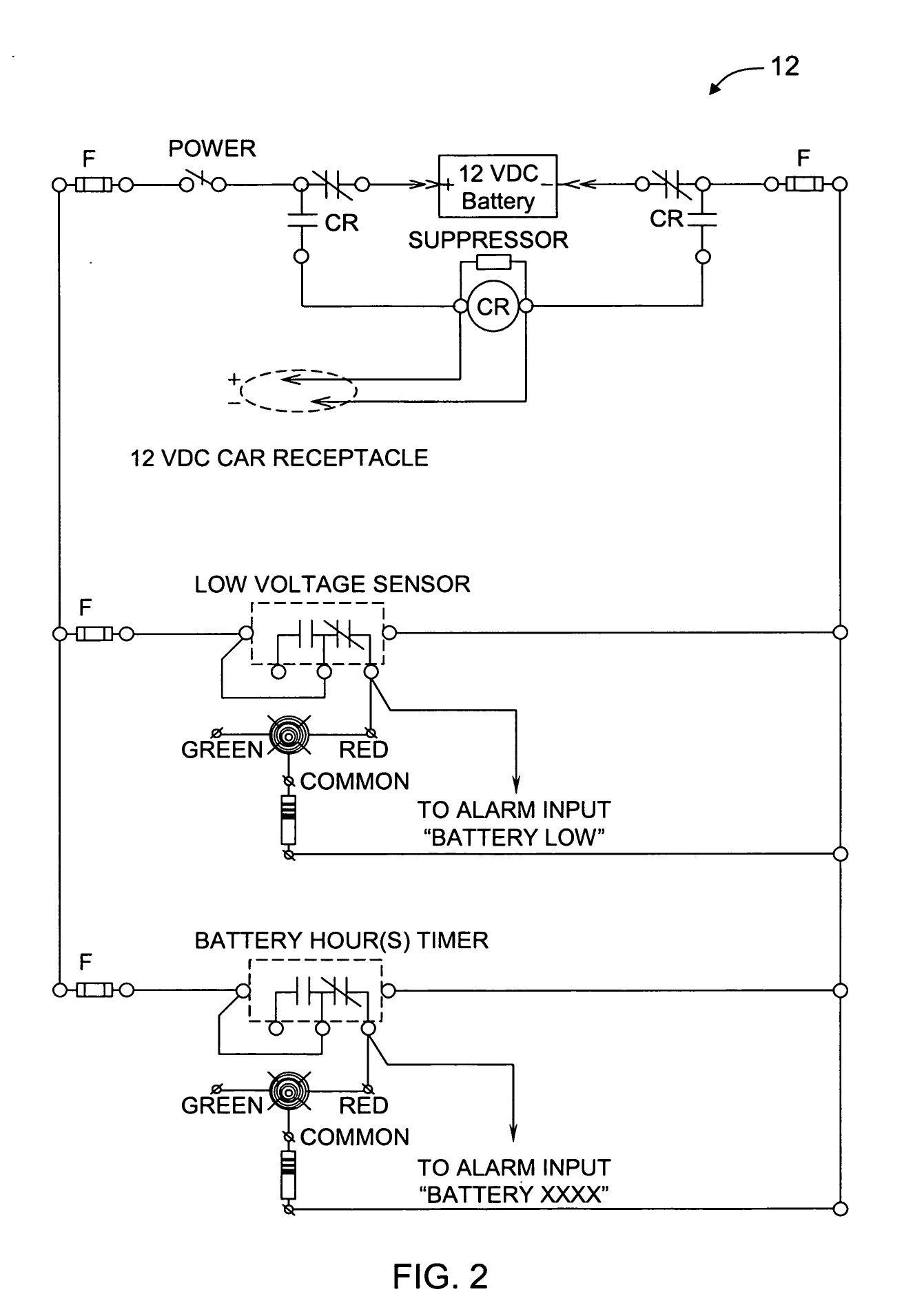

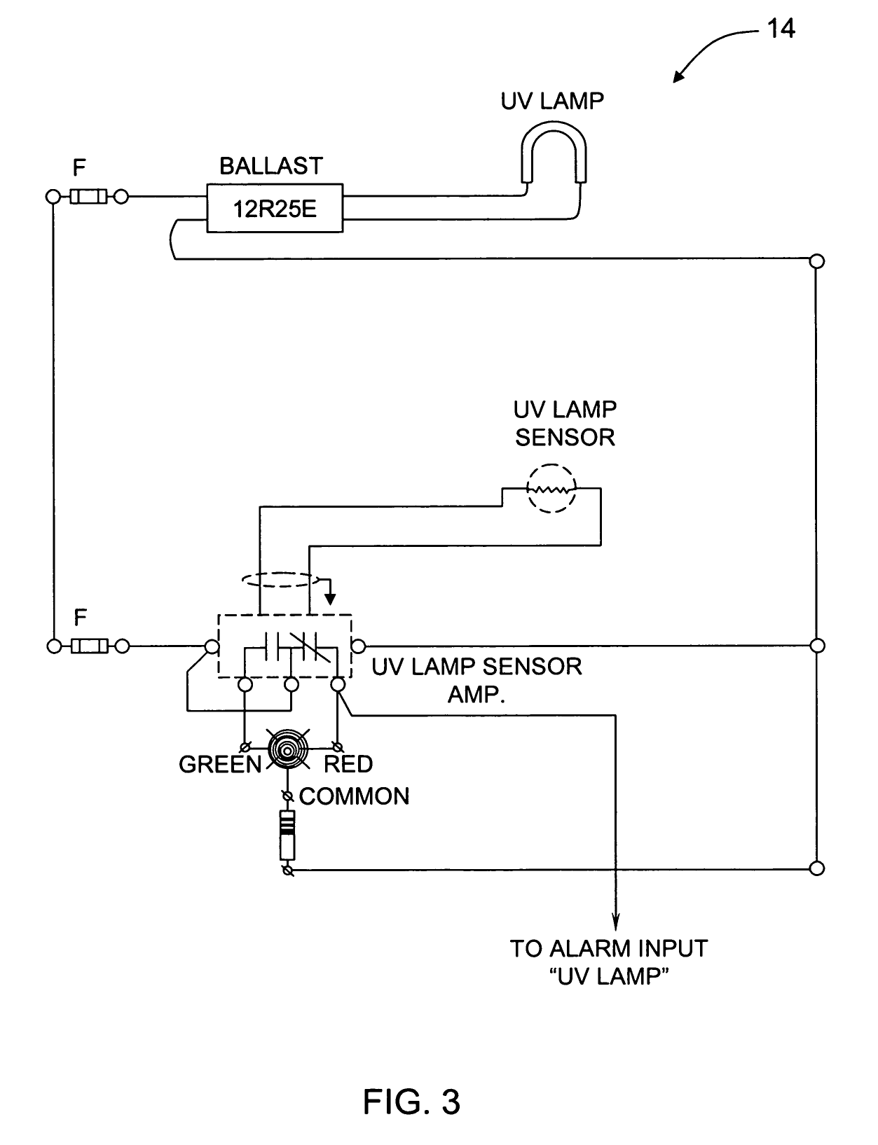

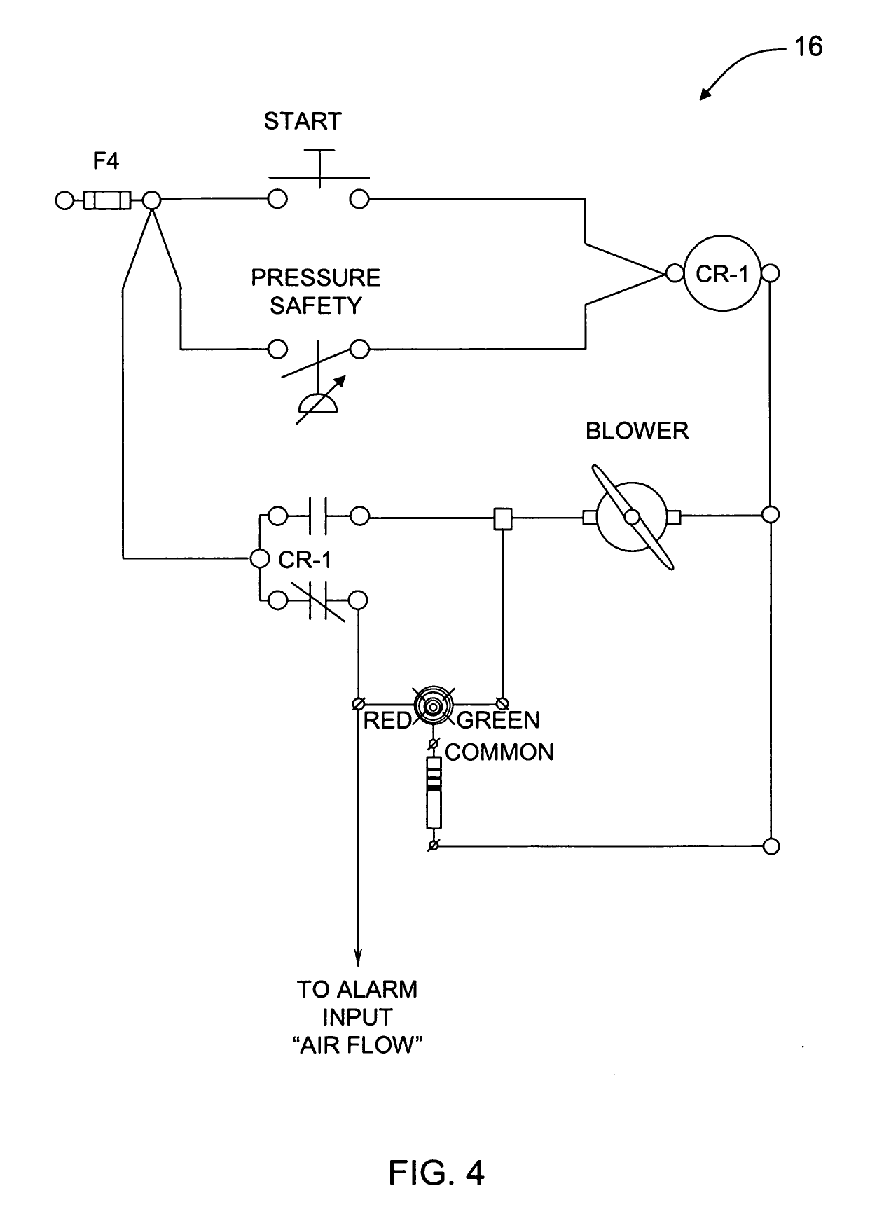

FIG. 1 is a schematic illustration of an exemplary breathing apparatus 10 that may be used to supply uncontaminated air to a user. FIG. 2 is a schematic illustration of an exemplary battery control circuit 12 that may be used with breathing apparatus 10. FIG. 3 is a schematic illustration of an exemplary lamp control circuit 14 that may be used with breathing apparatus 10. FIG. 4 is a schematic illustration of an exemplary blower control circuit 16 that may be used with breathing apparatus 10. In the exemplary embodiment, breathing apparatus 10 is a respirator that provides substantially biologically and chemically uncontaminated and germ-free breathable air to the user in hazardous environments, as described in more detail below. More specifically, as will be described in more detail below, in the exemplary embodiment, breathing apparatus 10 is a Powered Air Purifying Respirator (“PAPR”).

As used herein, the term “breathing apparatus,” refers to devices that facilitate provide substantially biologically and chemically uncontaminated and germ-free breathable air to the user in hazardous environments. As such, the methods and apparatus described herein are not limited to being PAPR as the present invention may be used with other types of breathing apparatuses. Moreover, as will be appreciated by one of ordinary skill in the art, the methods and apparatus described herein are not limited to use with portable or powered respirators, but rather the present invention may be used with other breathing apparatuses as well. For example, the present invention may be used with respirators used for air filtration, those that provide a positive pressure supply of air from a pressure vessel, or any combination thereof. As such, the following description is merely exemplary in nature and is in no way intended to limit the invention, its application, or uses.

In the exemplary embodiment, breathing apparatus 10 includes a face mask 30, a housing assembly 32, and a fluid connection apparatus or air supply hose 34 extending between mask 30 and housing assembly 32. In the exemplary embodiment, mask 30 includes a body 40, a transparent face shield or window 42, a seal (not shown), and a fastening harness (not shown). The seal extends around an outer periphery of the mask body 40 to facilitate preventing contaminants and untreated air from entering the mask 30. Specifically, in the exemplary embodiment, as described in more detail below, mask 30 is continuously pressurized such that the seal enables airflow to exit the mask continuously such that particulate is prevented from entering the mask from the outer periphery of the mask body 40. Mask body 40 is fabricated from a durable, heat-resistant, deformable material, such as, but not limited to a rubber material or a silicone/organic rubber blend material, that enables mask 30 to substantially confirm to the face of the user. Alternatively, mask body 40 may be fabricated from non-rubber materials.

In the exemplary embodiment, mask body 40 is generally concave along a vertical axis of mask 30 such that when mask 30 is positioned on the user, mask 30 forms an interior chamber (not shown) that is defined by body 40, face shield 42, and the face of the user. More specifically, in the exemplary embodiment, mask 30 is sized to substantially enclose the eyes, nose, and mouth of the user such that an airtight engagement is created between the seal and the face of the user.

The fastening harness maintains the airtight engagement between the user's face and mask 30. In the exemplary embodiment, the harness is adapted to engage the user's head at a plurality of positions to promote a secure engagement even during vigorous activity of the user. Alternatively, mask 30 may be coupled to, or incorporated into, a hard shell or a hood that is positioned over or outside of mask 30 to provide additional rigidity and/or structural protection.

In the exemplary embodiment, mask 30 is formed with an inlet 50 that enables a first end 52 of fluid connection apparatus 34 to be securely coupled to mask 30 for delivery of filtered air to mask 30. In an alternative embodiment, mask 30 may be formed with more than one inlet 50 depending on the application of mask 30. For example, in an alternative embodiment, mask 30 may include an inlet that enables mask 30 to be coupled in flow communication to a pressurized air tank. In another alternative embodiment, mask 30 may also be formed with an exhaust assembly that enables exhaust airflow to exit mask 30 during exhalation of the user and/or that enables the efflux of condensate and/or perspiration from the interior chamber of mask 30.

In the exemplary embodiment, housing assembly 32 includes a housing 62 that is formed as an integral, single unit that defines a substantially contiguous enclosure 64 therein. In an alternative embodiment, housing assembly 32 includes a plurality of housing members coupled integrally together. In the exemplary embodiment, housing assembly 32 is portable and may be carried by the user around their waist via a belt, on their back, or over their shoulder using a shoulder strap or any other suitable apparatus.

In the exemplary embodiment, housing assembly 32 is formed with a pair of inlet ports 70 and an exhaust port 72. Inlet ports 70, as described in more detail below, provide the only means for air to enter housing assembly 32 for treatment prior to being supplied to the user for breathing. A second end 74 of fluid connection apparatus 34 is coupled securely to exhaust port 72 to enable treated breathing air to be channeled to mask 30 for use the user.

Accordingly, air entering ports 70 is treated within housing assembly 32 prior to being exhausted through exhaust port 72 towards the user. To facilitate treating the air, in the exemplary embodiment, a battery assembly 80, a controller 82, a light source assembly 84, and a blower assembly 86 are positioned within housing assembly 32. Each component is described in more detail below. In an alternative embodiment, at least one of battery 80, controller 82, light source assembly 84, and/or blower assembly 86 is coupled independently of the remaining components. The housing 62 provides the primary support structure for components housed therein and for ports 70 and 72.

At least one filter canister 90 is removably coupled to each inlet port 70. As used herein, the term “filter canister” shall refer to any device used to adsorb, filter or detoxify airborne poisons, irritants, particulates, or the like, regardless of the physical shape of such device. In the exemplary embodiment, filter canisters 90 are passive filters that are designed to filter particulate matter from air being introduced to housing 62. For example, in one embodiment, filter canisters 90 use charcoal or other similar filtration materials to facilitate preventing the particulate contaminants from entering housing 62. The particular type of filter canisters 90 to be used will be dependent on the environment in which they are to be used as well as a wide variety of other factors apparent to those of ordinary skill in the art, but one filter canister suitable for use in at least some implementations of the PAPR 40 of the present invention is a NIOSH approved enforcement cartridge filter that provides protection against particles and gases (part no. 045123) and commercially available from Tyco/Scott Health & Safety, Pittsburgh, Pa.

In the exemplary embodiment, each inlet port 70 is substantially cylindrical to enable a single filter canister 90 to be coupled thereto. It should be apparent to one of ordinary skill in the art that other inlet shapes and configurations are possible, such as a T-shaped inlet or a Y-shaped inlet which accommodates multiple filter canisters 90. In the exemplary embodiment, two inlet ports 70 are provided and each is of a standard size and includes a coupling mechanism to permit various accessories, including but not limited to canisters 90, cover plates, or intake devices, to be coupled thereto. It will also be apparent to one of ordinary skill in the art that other embodiments may include more or less than two inlet ports 70. Moreover, in other embodiments, the orientation, relative location, and/or overall size and shape of inlet ports 70 may be different than those illustrated.

When coupled to inlet ports 70, each filter canister 90 is in flow communication with a flow path 100 defined within housing 62. Specifically, in the exemplary embodiment, flow path 100 extends from inlet ports 70 to an active filter 102 removably coupled within housing 62. Specifically, filter 102 is positioned such that all airflow entering housing 62 through inlet ports 70 is channeled through filter 102 prior to being exhausted into fluid connection apparatus 34. In the exemplary embodiment, filter 102 is a high efficiency particulate air (HEPA) filter or an ultra-low penetration air filter (ULPA) that is designed to remove hazardous biological contaminants, including but not limited to bacteria and viruses, from airflow being treated for use by the user. For example, in one embodiment, filter 102 is a ULPA filter commercially available from Camfil Farr, Jonesboro, Ark. and is designed to remove 99.999% of all airborne particulates sized 0.12 microns or larger, including bacterial, and viral contaminants. In another embodiment, filter 101 is also designed to remove toxic chemicals from airflow being treated for use by the user.

In one embodiment, filter 102 may be multi-staged and include an active ingredient layer that facilitates killing, destroying, inactivating, or rendering harmless, any biological matter, germicidal matter, bacteria, spores, and viruses that entered housing 62 through inlet ports 70. For example, the active ingredient layer may include any known antibacterial, antibiotic, bacteriostatic or antiviral agents that facilitate physically absorb contaminants, whether in solid, liquid, gaseous form, or as vapors or particles mixed or suspended in air.

Light source assembly 84 includes a high intensity light source 110 and ballast 112. In alternative embodiment, light source assembly 84 includes more than one light source 110. In the exemplary embodiment, light source 110 is a low pressure mercury vapor lamp that emits ultraviolet light with an optimal emission distribution and that is positioned within flow path 100 such that substantially all fluid flow entering housing 62 is continuously exposed to ultraviolet light emitted from source assembly 84 prior to entering filter 102. For example, in one embodiment, light source 110 is commercially available from Light Sources, Incorporated, Orange, Conn. Moreover, filter 102 is also positioned adjacent to light source 110 such that contaminants trapped within or against filter 102 are also exposed to ultraviolet light emitted therefrom. In the exemplary embodiment, as described in more detail below, light source 110 emits a high intensity ultraviolet light into flow path 100 and filter 102 to facilitate killing, destroying, inactivating, or rendering harmless, any biological matter, germicidal matter, bacteria, spores, and viruses within flow path 100 and those contained in, or trapped against, filter 102.

In the exemplary embodiment, light 110 emits ultraviolet light at an intensity of between 245 to 265 nanometers (nm), and preferably at an intensity of between 250 to 260 nm. As such, contaminates within the fluid flow are exposed to approximately one-hundred mWsec/cm² of energy in approximately one minute of exposure to filter 102. Microbes are uniquely vulnerable to the effects of light at wavelengths at or near 2537 Angstroms due to the resonance of this wavelength with the molecular structures. More specifically, as is known in the art, a quanta of energy of ultraviolet light possesses the right amount of energy to break organic molecular bonds which translates into cellular or genetic damage for microorganisms. The combination of the shape and length of flow path 100, the relative velocity of the fluid flowing through flow path 100, and the intensity and location of lights 110 ensures that any biological and germicidal entrained in the fluid flowing through flow path 100 and/or captured within or against filter 102 are exposed for a time duration and an intensity of ultraviolet light to facilitate killing, destroying, inactivating, or rendering harmless, such particles. As such, if power to light source 110 is removed for a brief period of time during use of apparatus 10, when light source 110 is reenergized, contaminants captured within or against filter 102 are then exposed at an intensity of ultraviolet light to facilitate killing, destroying, inactivating, or rendering harmless, such particles.

Blower assembly 86 is coupled in flow communication with flow path 100 to facilitate maintaining a positive pressure air flow to mask 30. In an alternative embodiment, housing assembly 32 does not include blower assembly 86 and breathing apparatus 10 is usable without the assistance of mechanical airflow. Specifically, in the exemplary embodiment, blower assembly 86 is coupled in flow communication between inlet ports 70 and exhaust port 72 to facilitate providing the user with enough air flow, at a constant flow rate, to maintain a positive pressure within mask 30. For example, in the exemplary embodiment, blower assembly 86 provides approximately at least six CFM of airflow to mask 30 to maintain positive pressure within mask 30. The blower assembly 86 functions to pull air through inlet ports 70 and through filter canisters 90 and into housing 62 wherein the air is drawn past light source 110 and through filter 102 prior to being pumped through hose 34 and into the interior of mask 30. In one embodiment, the blower assembly 86 is an electronically-controlled centrifugal fan. Alternatively, blower assembly 86 includes any suitable low profile fan, impeller, rotary air pump, or any other device that enables breathing apparatus 10 to function as described herein. In one embodiment, blower assembly 86 is an ITT Jabsco-Par Brand Blower.

Blower assembly 86 and each component within breathing apparatus 10 is electrically powered by battery assembly 80. Battery assembly 80 provides a low voltage direct current. In an alternative embodiment, housing assembly 32 may include an inverter and be powered by alternating current. In the exemplary embodiment, battery assembly 80 includes a plurality of rechargeable nickel metal hydride (NiMH) batteries. Alternatively, battery assembly 80 may include other rechargeable batteries, such as, but not limited to, nickel-cadmium (NiCd), lithium ion, or may include non-rechargeable, disposable batteries. In one embodiment, housing assembly 10 may also include a receptacle that enables the batteries to be recharged through a battery charger or through a 110 volt automobile receptacle.

Operation of breathing apparatus 10 is controlled by controller 82, which includes a user interface (not shown) and electrical circuits, such as circuits 12, 14, and 16, to facilitate control and energization of breathing apparatus 10 through battery assembly 80, operation of light source assembly 84, and operation of blower assembly 86. In one embodiment, controller 82 is a Pico Controller programmable logic controller commercially available from Rockwell Automation, Milwaukee, Wis. In one embodiment, the user interface is contained in separate unit that may be carried in a location convenient for the user to see and manipulate. The user interface includes a simple on/off switch (not shown) for manually activating and deactivating blower assembly 86, as well as a battery status indicator (not shown). In one embodiment, battery assembly 80 may be contained in the same unit as the user interface.

In the exemplary embodiment, controller 82 is electrically coupled to either a visual alarm panel (not shown) and/or an audible alarm, and to a plurality of sensors mounted within housing assembly 32, such as but not limited to, a pressure sensor, an ultraviolet light sensor, a voltage sensor, and a battery sensor. Moreover, the visual alarm panel includes a plurality of light emitting diodes (LED) that provide a visual indication of a current operational status of breathing apparatus 10. For example, a first LED may provide a visual indication as to whether breathing apparatus 10 is operating in a powered mode or not (i.e., if the first LED is illuminated, then breathing apparatus 10 is currently powered on). A second LED (not shown) may be used to provide a visual indication as to whether the breathing apparatus 10 is in an alarm state or not. For example, the second LED or the audio alarm may be illuminated if batteries within battery assembly 80 are low or are below a pre-determined useful life, if the flow of air exiting blower assembly 86 is below a predetermined threshold (such as 6 CFM) as measured by a pressure sensor, or if the intensity output of light source 110 falls below a predetermined value, such as 50%, as measured by a low voltage sensor, a UV sensor, or a photo-electric eye positioned within housing assembly. For example, in one embodiment, a Compact Sensor commercially available from E.I.T., Inc., Sterling, Va., is used to monitor an intensity output of light source 110.

In addition, the second LED or the audio alarm may be activated after a predetermined amount of usage time, such as three hours, for example, has elapsed, when breathing apparatus 10 is powered by battery assembly 80. Moreover, if a sensed pressure differential across filter 102 exceeds a predetermined value, the second LED or audio alarm may be activated. In addition,

During operation, in the exemplary embodiment, air is drawn through filter canisters 90 and into housing inlet ports 70. Filter canisters 90 remove particulate matter from such air flow prior to discharging the air flow into housing flow path 100. It should be noted that in one embodiment, mask 30 may include a fluid dam device configured to prevent water and any other liquid entering mask 30 through inlet ports 70 from flowing through filter 102 and damaging filter 102. At any time, filter canisters 90 may be exchanged without compromising the safety of the user. Moreover, filter 102, and/or battery assembly 80 may also be exchanged during operation of breathing apparatus 10.

Air discharged from inlet ports 70 is exposed to high intensity ultraviolet light within fluid path 100 and when captured within or against filter 102. As the air flows through flow path 100, the air is exposed to and is subjected to exposure of high intensity ultraviolet light such that any biological matter, germicidal matter, and/or virus is facilitated to be killed, destroyed, inactivated, or rendered harmless. The air is then filtered through filter 102 and is pumped via blower assembly 86 towards mask 10 for inhalation by the user. Because light source 110 is upstream from filter 102, the useful life of filter 102 is facilitated to be extended as biological matter, germicidal matter, and/or viral matter is facilitated to be killed, destroyed, inactivated, or rendered harmless prior to the flow being filtered by filter 102.

Exemplary embodiments of breathing apparatuses are described above in detail. Although the methods and apparatuses described herein for use in supplying purified air to a user are herein described and illustrated in association with the above-described breathing apparatus, it should be understood that the present invention may be used with any breathing apparatus. More specifically, the ultraviolet emissions methods and apparatuses used for killing, destroying, inactivating, or rendering harmless, biological matter, germicidal matter, and/or viral matter, are not limited to the specific embodiments described herein, but rather, aspects of each breathing apparatus and/or method of supplying purified air to a user may be utilized independently and separately from other breathing apparatuses and/or air purification methods.

Moreover, based on the foregoing information, it is readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to its exemplary embodiment, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof. Although specific terms are employed herein, they are used in a generic and descriptive sense only and not for the purpose of limitation.

What is claimed is:

1. A respirator comprising:
a face mask comprising an inlet opening and a seal, said inlet opening configured to channel treated air into said face mask, said face mask seal configured to prevent contaminants and untreated air from entering said mask; and
a housing assembly coupled in flow communication to said face mask inlet opening, said housing assembly comprising a first filter assembly, a second filter assembly coupled in flow communication downstream from said first filter assembly, and an ultraviolet light source coupled in flow communication between said first and second filter assemblies, said ultraviolet light source configured to substantially prevent microorganisms discharged from said first filter assembly being discharged to the user through said second filter assembly.

2. A respirator in accordance with claim 1 wherein said ultraviolet light source is configured to emit ultraviolet light in a range of approximately 250 nanometers to approximately 260 nanometers.

3. A respirator in accordance with claim 1 wherein said first filter assembly comprises an activated charcoal filter.

4. A respirator in accordance with claim 1 wherein said second filter assembly comprises an ULPA filter media.

5. A respirator in accordance with claim 1 wherein said second filter assembly is positioned in close proximity to said ultraviolet light source such that any particles retained against and within said second filter assembly are exposed to said ultraviolet light source.

6. A respirator in accordance with claim 1 further comprising a blower configured to draw air into said housing assembly through said first filter assembly.

7. A respirator in accordance with claim 6 wherein said blower is battery-powered.

8. A respirator in accordance with claim 6 wherein said blower is configured to maintain a positive pressure within said face mask.

9. A respirator in accordance with claim 1 wherein each of said first filter assembly and said second filter assembly is individually and removably coupled to said housing assembly.

10. A respirator in accordance with claim 1 wherein said housing assembly further comprises at least one of a pressure sensor, an ultraviolet light sensor, and a battery sensor.

11. An air-purifying respirator, comprising:
an enclosure, defining a single substantially contiguous enclosed interior;
at least one inlet that guides ambient air to the interior of said enclosure;
a filter assembly disposed within said enclosure;
a fluid connection apparatus that guides filtered air from an outlet of said filter assembly to be breathed by a user; and
a light source disposed in an air path upstream from said filter assembly, said light source configured to prevent microorganisms from entering said fluid connection apparatus through said filter assembly.

12. A respirator in accordance with claim 11 wherein said ultraviolet light source is configured to emit ultraviolet lights in a range of approximately 250 nanometers to approximately 260 nanometers.

13. A respirator in accordance with claim 11 further comprising a blower configured to draw air into said housing assembly through said filter assembly.

14. A respirator in accordance with claim 13 wherein said blower is battery-powered.

15. A respirator in accordance with claim 13 wherein said blower is configured to induce a positive pressure to the user during use.

16. A respirator in accordance with claim 11 further comprising at least one of a pressure sensor, an ultraviolet light sensor, a voltage sensor, and a battery sensor positioned within said enclosure.

17. A respirator in accordance with claim 16 further comprising at least one of an audible alarm and a visual alarm configured to activate upon one of a predetermined differential pressure being sensed, a predetermined light intensity being sensed, a predetermined blower voltage being sensed, and after a predetermined operating time has elapsed.

18. A respirator in accordance with claim 11 wherein said filter assembly comprises a ULPA media configured to filter out particles from air channeled to said fluid connection apparatus above a predetermined size.

19. A respirator in accordance with claim 19 wherein said filter assembly further comprises an absorbent media for removing predetermined substances from air channeled to said fluid connection apparatus.

20. A powered air-purifying respirator (PAPR), comprising:
a PAPR housing configured to be carried by a user, said PAPR housing comprising at least one inlet port for receiving air to be channeled to the user;
a first filter assembly coupled in flow communication to said at least one housing inlet port externally to said housing;
a second filter assembly coupled in flow communication downstream from said first filter assembly via a flow path defined within said housing;
an ultraviolet light source coupled in flow communication within said flow path, said ultraviolet light source adapted to expose air discharged from said first filter assembly to ultraviolet light for a predetermined amount of time to facilitate preventing microorganisms from being inhaled by the user; and
a blower that draws air into said PAPR housing through said first filter assembly.

21. A PAPR in accordance with claim 20 further comprising a pressure sensor disposed within said housing, said pressure sensor configured to activate an alarm if a differential pressure across said filter assembly exceeds a predetermined value.

22. A PAPR in accordance with claim 20 further comprising a voltage sensor disposed within said housing, said voltage sensor configured to activate an alarm if intensity of light output from said ultraviolet light source is decreased by a predetermined value.

23. A PAPR in accordance with claim 20 further comprising a voltage sensor disposed within said housing, said voltage sensor configured to activate an alarm if output from said blower is decreased by a predetermined value.

24. A PAPR in accordance with claim 20 further comprising a timer configured to activate an alarm after a predetermined amount of operation time of said PAPR has elapsed.

25. A breathing system comprising:
a powered air-purifying respirator having a PAPR enclosure and a blower that pulls air through said PAPR enclosure, said PAPR enclosure comprising a light source and a filter assembly downstream from said light source;
a facepiece configured to cover a user's nose and mouth in a substantially airtight connection; and
an air path coupling said facepiece to said powered air-purifying respirator, said light source configured to facilitate preventing microorganisms from being inhaled by the user through said filter assembly.

26. A breathing system in accordance with claim 25 wherein said light source is configured to emit ultraviolet light in a range of approximately 250 to approximately 260 nanometers.

27. A breathing system in accordance with claim 25 wherein said filter assembly comprises a ULPA filter media configured to filter out particles from air channeled to said air path above a predetermined size.

28. A breathing system in accordance with claim 25 wherein said blower is configured to maintain a positive pressure within said facepiece.

29. A breathing system in accordance with claim 25 wherein said blower is battery-powered.

30. A breathing system in accordance with claim 25 further comprising a pressure sensor configured to activate an alarm if a differential pressure across said filter assembly exceeds a predetermined value.

31. A breathing system in accordance with claim 25 further comprising a voltage sensor configured to activate an alarm if intensity of light output from said light source is below a predetermined value.

32. A breathing system in accordance with claim 25 further comprising a voltage sensor configured to activate an alarm if output from said blower is below a predetermined value.
